(19) United States
(12) Patent Application Publication
(10) Pub. No.: US 2006/0053689 A1
(43) Pub. Date: Mar. 16, 2006

(54) Adjustable plant support

(76) Inventor: Dudley Smith, Napa, CA (US)

Correspondence Address: DUDLEY SMITH, 477 COOMBS STREET, NAPA, CA, 94559, US

(21) Appl. No.: 10/939,400

(22) Filed: Sep. 14, 2004

(51) Int. Cl. A01G 17/06

(52) U.S. Cl. 47/45

(57) ABSTRACT

An adjustable plant support system with a vertically oriented shaft, an adjustable clamp assembly and a horizontally oriented shaft. The clamp assembly is capable of releasably retaining both the vertical shaft and the horizontal shaft. A preferred embodiment includes the clamp assembly having a rigid body with a vertically disposed aperture, a horizontally disposed aperture and a U shaped cutout area located in front of the apertures that receives a cam type clamping lever that is rotatably pinned to the remaining upper and lower legs formed by the U shaped cutout. The vertical aperture and the horizontal aperture are in adjoining proximity to each other so that when the shafts are in place, the cam lever pushes against the vertical shaft which in turn pushes against the horizontal shaft thereby locking them in place.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of plant supports and more specifically to an adjustable plant support. When growing plants such as tomatoes, it is advisable to provide additional physical support for the growing vines that need to stay off the ground. A number of vine supporting devices are currently on the market. One such type is a wire frame comprised of a series of vertically stacked circular hoops that are welded to a plurality of vertical rods. These types of supports act as a cage for the plant, However, the tomato vines are prone to growing beyond the cage and have no means of support. Additionally, other types of plant stakes such as vertical posts that include tie wraps to hold vines in place, can not be easily re-adjusted as the plant and vines grow. Finally, the current designs for plant supports are not modular and can not be assembled to accommodate unusually shaped plants and foliage.

### BRIEF SUMMARY OF THE INVENTION

The primary object of the invention is to provide a plant support that can be adjusted to any height.

Another object of the invention is to provide a plant support that can cradle a vine.

Another object of the invention is to provide a plant support that can be re-adjusted even when a vine is in place.

A further object of the invention is to provide a plant support that can be adjusted vertically and horizontally.

Yet another object of the invention is to provide a plant support that is modular so that a plurality of supports can be attached together.

Still yet another object of the invention is to provide a plant support that is easy and inexpensive to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an adjustable plant support system comprising: a plurality of vertically oriented shafts, adjustable clamp assemblies, horizontally oriented shafts, said clamp assembly capable of releasably retaining both said vertical shaft and said horizontal shaft.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the clamp portion of the present invention.

FIG. 3 is a top view of the clamp portion of the present invention.

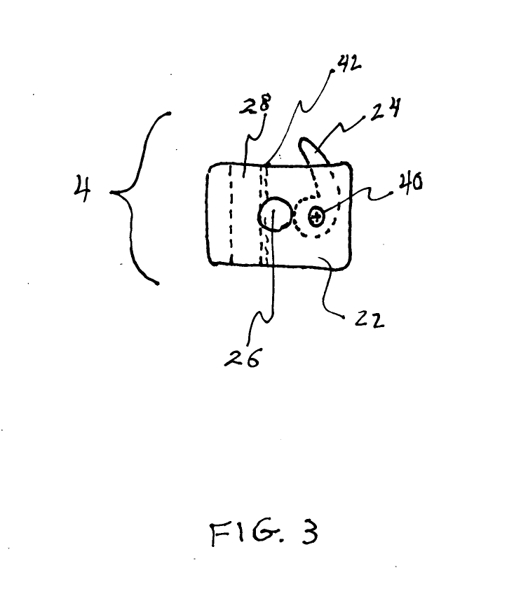

FIG. 4 is an exploded view of a vine retaining accessory.

FIG. 5 is an exploded view of a horizontal support connector.

### DETAILED DESCRIPTION OF THE PREFERRED EMBODIMENTS

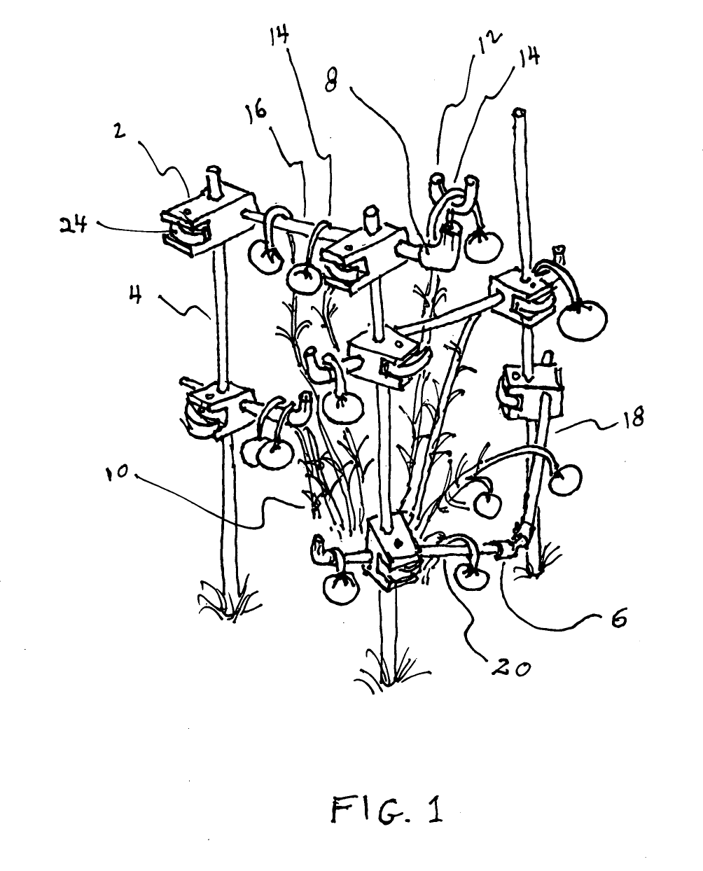

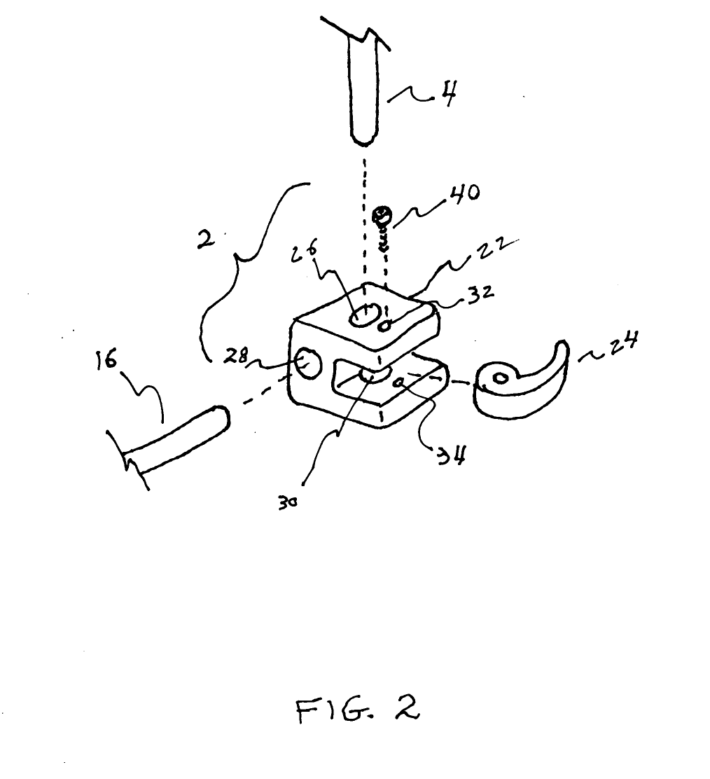

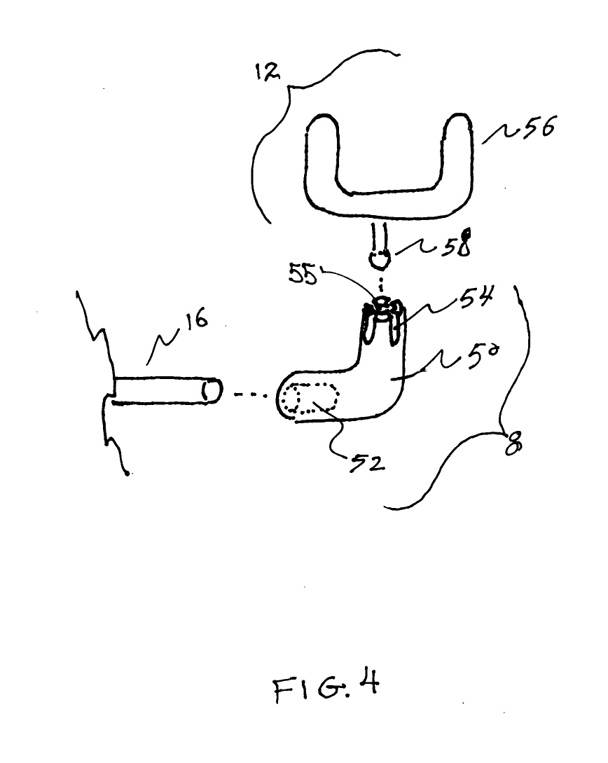

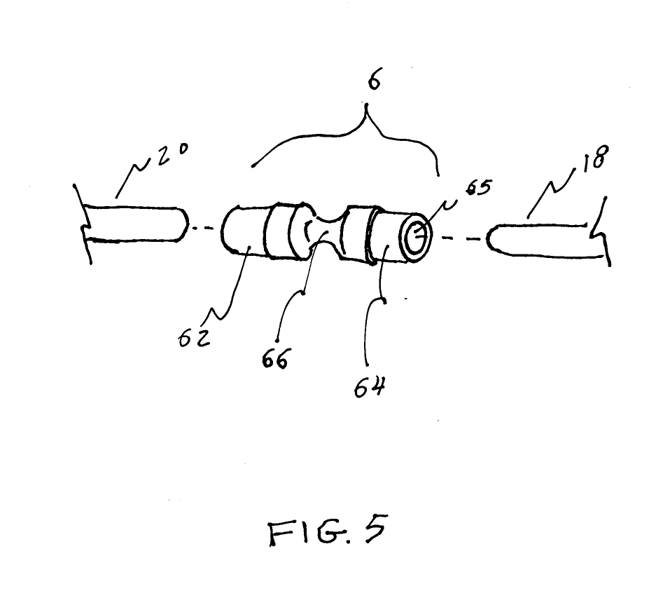

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring now to FIG. 1 we see a perspective view of a tomato plant 10 whose vines 14 are being supported by the support system of the present invention. The support system is comprised of a plurality of vertical rods 4, horizontal rods 16, clamp portions 2, rod connectors 6 and vine retaining end caps 12 and 8. Obviously, a variety of support configurations can be assembled by adding additional above mentioned components. Clamps 2 can be loosened and tightened again by rotating cam lock 24 clockwise and counter clockwise respectively. The clamps 2 can slide up or down on the vertical rods 4 or left to right on the horizontal rods 16. L shaped horizontal rod tips 8 can be frictionally added to help retain vines 14 and prevent them from falling off of horizontal rods 16. A flexible joint 6 allows the user to connect one horizontal rod 20 with another 18. A Y shaped addition 14 can plug onto the tip of L shaped retaining tips 8. The Y shape can rotate in its receptacle so it can cradle a vine 14 no matter angle it needs to be supported in. FIG. 2 shows an exploded view of the clamp portion 2. The main body 22 is constructed of rigid material such as injection molded high impact plastic which includes UV inhibitors. aperture 28 allows horizontal rod 16 to slide into the main body 22. Aperture 26, 30 allows vertical rod 4 to slide through the main body 22. Rotatable cam lever 24 is pinned into a U shaped cutout in main body 22 by screw post 40. A top view of main body 4 shows that aperture 28 and aperture 26 intersect each other slightly so that when cam lever 24 is tightened it clamps both vertical rod 40 and horizontal rod 16. Dotted line 42 indicates the interior wall of the U shaped cutout. FIG. 4 shows an exploded view of the L shaped tip 8 and Y shaped addition 12. The L portion 50 includes an aperture 52 that can provide a frictional fit to rod 16. The recommended construction of the support rods 4, 16 is a tubular steel construction clad in a plastic sheath such as the Blue Ribbon/Sturdy Stake support rods manufactured by California Plastic Products of Denver, Colo. In the preferred embodiment the rods used in my design are three eights of an inch in diameter. Because of the slightly compressible nature of the plastic sheath on the rods 4, 16, allows a frictional fit between aperture 52 and rod 16 end as well as the clamping ability of cam 24. The top portion of L shaped tip 50 includes a plurality of vertical slots 54 that deflect when the ball portion 58 of Y 56 is inserted into aperture 55 thereby creating a swivel effect for Y assembly 12. FIG. 5 shows a connector 6 that is comprised of a pair of opposed retaining tubes 62, 64 held together by shrink wrap tubing 66 that forms a flexible joint. The apertures form a frictional fit with the tips of horizontal rods 20, 18. The present invention allows the user to create a wide variety of sizes and shapes for supporting the vines or branches of a plant. The support clamps can be re-adjusted and moved at any time without removing or disturbing the vines of the plant. The plant support system of the present invention is easy and inexpensive to manufacture. The system may be expanded easily by using additional identical clamps and retaining tips.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. aAdjustable plant support system comprising:
a vertically oriented shaft;
an adjustable clamp assembly;
a horizontally oriented shaft; and
said clamp assembly capable of releasably retaining both said vertical shaft and said horizontal shaft.

2. Adjustable plant support system as claimed in claim 1 wherein said clamp assembly includes a rigid body with a vertically disposed aperture, a horizontally disposed aperture and a U shaped cutout area located in front of said apertures that receives a cam type clamping lever that is rotatably pinned to the remaining upper and lower legs formed by said U shaped cutout;
said vertical aperture and said horizontal aperture in adjoining proximity to each other so that when said shafts are in place, said cam lever pushes against said vertical shaft which in turn pushes against said horizontal shaft thereby locking them in place.

3. Adjustable plant support system as claimed in claim 1 further comprising of three different horizontal shaft end additions that removably plug onto the ends of said shaft, one said addition type consisting of a universal joint that allows the end of one horizontal shaft to be connected to the end of a second horizontal shaft, another end addition forming an upwardly biased L shape that can prevent a plant vine from falling off said shaft and a third addition comprising a rotatable, upwardly biased Y shape that can cradle a vine no matter what direction it is growing in.

4. Adjustable plant support system as claimed in claim 1 wherein said shaft members are approximately three eigths of an inch in diameter and are constructed of steel tubing covered in a plastic sleeve;
said sleeve being somewhat compressible to assist in said clamping action.

5. Adjustable plant support system as claimed in claim 1 wherein said clamp assembly and said shaft end additions are injection molded from high impact, UV resistant plastic.
